(19) United States
(12) Patent Application Publication
(10) Pub. No.: US 2006/0127063 A1
(43) Pub. Date: Jun. 15, 2006

(54) Optical disc apparatus

(75) Inventor: Shinsuke Matsumoto, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/302,136

(22) Filed: Dec. 14, 2005

(30) Foreign Application Priority Data
Dec. 15, 2004 (JP) 2004-362941

(51) Int. Cl. H04N 5/85

(52) U.S. Cl. 386/126

(57) ABSTRACT

The present invention provides an optical disc apparatus that records information on an optical disc in accordance with the UDF standard. A volume recognition sequence is data indicating that the file system used for organizing information recorded on an optical disc is a UDF file system, and is written to sectors on the optical disc that are specified in the UDF standard. When information is to be recorded on an optical disc, the optical disc apparatus writes a volume recognition sequence to specified sectors on the optical disc if the optical disc is blank and it does not write the volume recognition sequence if the optical disc is not blank. This can prevent an existing volume recognition sequence on the specified sectors of the optical disc from being unnecessarily overwritten when information is additionally recorded on the optical disc. Accordingly, the sectors can be protected from damage or wear due to repeated writing.

### BACKGROUND OF THE INVENTION

1. Field of the Invention

The present invention relates to an optical disc apparatus that records information onto an optical disc such as a DVD or the like.

2. Description of the Related Art

Optical disc apparatus are known that record video, audio, text, and other information on optical discs in accordance with the universal disk format (UDF) standard. Such an optical disc apparatus is designed to write a UDF file system, which is management information used for organizing information recorded on an optical disc in accordance with the UDF standard, to specified sectors on the optical disc. The UDF file system includes management information such as, for example, a volume recognition sequence, a main volume descriptor sequence, a reserve volume descriptor sequence, a logical volume integrity sequence, a first anchor point, and a second anchor point, which are written to the sectors specified in the UDF standard.

When information such as video, audio, and/or text is to be recorded on an optical disc, the conventional optical disc apparatus creates a new UDF file system based on a UDF file system previously written on the optical disc and the information to be recorded on the optical disc, and writes the newly created UDF file system to the optical disc. More particularly, the conventional optical disc apparatus creates a new UDF file system for rewriting every time it additionally records information onto an optical disc. Regardless of the presence or absence of changes in the UDF file system, the conventional optical disc apparatus rewrites the entire UDF file system each time it records additional information.

As described above, the UDF file system is written to specific sectors on an optical disc that are defined in the UDF standard. Therefore, the specific sectors used for writing the UDF file system are more likely to be damaged or worn from repeated use and thus become defective than other sectors on the optical disc.

According to the conventional optical disc apparatus, an entire UDF file system is rewritten regardless of the presence or absence of changes in the UDF file system each time additional information is to be recorded on an optical disc as described above. In other words, the conventional optical disc apparatus may unnecessarily rewrite data for a portion of the UDF file system that has no change. This increases the possibility that the sectors used for the writing of the UDF file system become defective.

A number of other techniques have been proposed. For example, an optical recording medium is known that has a plurality of areas used for storage of file management information that is frequently rewritten in order to prevent deterioration of only a certain area (see e.g. Japanese laid-open patent publication 2001-291367). A recording medium is also known that has a spare area including a replacement area that can be used in place of a defective area in a user area (see e.g. Japanese laid-open patent publication 2001-325773). Further, an information recording apparatus is known that changes an area on a recording medium that is used for recording specific information such as management information every time the specific information is updated a predetermined number of times in order to prevent a partial deterioration of the recording medium due to repeated writings to only a certain area (see e.g. Japanese laid-open patent publication 2004-79125). An information recording apparatus is also known that records information indicating the location where the content of a file is recorded doubly as original information and backup information on a recording medium in order to increase the security of the information (see e.g. Japanese laid-open patent publication 2003-6017). However, the above described problem cannot be solved even if the above techniques are applied.

### SUMMARY OF THE INVENTION

An object of the present invention is to provide an optical disc apparatus that can avoid unnecessary rewriting of a file system so as to protect sectors used for writing the file system from damage or wear.

According to an aspect of the present invention, an optical disc apparatus comprises: recording and reading means for recording and reading information to and from an optical disc; and control means for controlling the recording and reading of information to and from the optical disc in accordance with a universal disk format (UDF) standard. The control means includes UDF file system writing means for, when information is to be recorded on the optical disc, reading information previously written on the optical disc by the recording and reading means and writing, by the recording and reading means, at least a portion of a UDF file system onto the optical disc based on the information read from the optical disc and the information to be recorded on the optical disc, wherein the UDF file system is information used for organizing information recorded on the optical disc in accordance with the UDF standard and includes a volume recognition sequence, a main volume descriptor sequence, a reserve volume descriptor sequence, a logical volume integrity sequence, a first anchor point, and a second anchor point. The UDF file system writing means performs a recognition sequence writing operation in which, if it is determined that the optical disc is blank, the volume recognition sequence is written to specified sectors on the optical disc, and if it is determined that the optical disc is not blank, the volume recognition sequence is not written to the optical disc.

The volume recognition sequence is data indicating that the file system used for organizing information recorded on the optical disc is the UDF file system. Thus, there is no need to change the volume recognition sequence when information is additionally recorded on the optical disc. With the above configuration, when information is to be recorded on the optical disc, the volume recognition sequence is written to the sectors on the optical disc that are specified in the UDF standard if the optical disc is a blank disc. Otherwise if the optical disc is not blank, the volume recognition sequence is not written to the optical disc. If the optical disc is blank, i.e., if the optical disc has no data recorded in accordance with the UDF standard, the optical disc has no volume recognition sequence written thereon and thus needs writing of the volume recognition sequence. Therefore, the volume recognition sequence is written to the optical disc. On the other hand, if the optical disc is not blank, i.e., if the optical disc has data previously recorded in accordance with the UDF standard, the optical disc should have a volume recognition sequence previously written thereon and thus does not need rewriting of the volume recognition sequence. Therefore, the volume recognition sequence is not written to the optical disc. This can prevent an existing volume recognition sequence on the specific sectors of the optical disc, which are defined in the UDF standard, from being unnecessarily overwritten when additional information is to be recorded on the optical disc. Accordingly, the specific sectors used for storage of the volume recognition sequence can be protected from damage or wear.

Preferably, the determination as to whether the optical disc is blank or not is performed by determining whether or not the optical disc has a volume recognition sequence previously written thereon.

Preferably, the UDF file system writing means performs a volume sequence writing operation for writing the main volume descriptor sequence, the reserve volume descriptor sequence, and the logical volume integrity sequence to specified sectors on the optical disc after it is determined that the optical disc is not blank or after it is determined that the optical disc is blank and thus the volume recognition sequence is written to the optical disc, and if a writing error arises at the volume sequence writing operation, the UDF file system writing means performs an error recovery operation for writing the main volume descriptor sequence, the reserve volume descriptor sequence, and the logical volume integrity sequence to reserved sectors on the optical disc.

With the above configuration, each time information is recorded on the optical disc, the main volume descriptor sequence, the reserve volume descriptor sequence, and the logical volume integrity sequence, which have to be changed at each recording of information, are written (rewritten) to the sectors on the optical disc that are specified in the UDF standard. If an error arises at the writing, the three pieces of data are written to the reserved sectors on the optical disc. Accordingly, even when a writing error due to a defective sector arises at the writing of the main volume descriptor sequence, the reserve volume descriptor sequence, and the logical volume integrity sequence, the writing can be recovered.

It is preferable that the UDF file system writing means performs a volume sequence writing operation for writing the main volume descriptor sequence, the reserve volume descriptor sequence, and the logical volume integrity sequence to specified sectors on the optical disc after it is determined that the optical disc is not blank or after it is determined that the optical disc is blank and thus the volume recognition sequence is written to the optical disc, wherein if a writing error arises at the volume sequence writing operation, the UDF file system writing means performs a first error recovery operation for writing the main volume descriptor sequence, the reserve volume descriptor sequence, and the logical volume integrity sequence to reserved sectors on the optical disc, wherein after the main volume descriptor sequence, the reserve volume descriptor sequence, and the logical volume integrity sequence are written to the optical disc by either the volume sequence writing operation or the first error recovery operation, the UDF file system writing means performs a first anchor point writing operation in which, if there is a change in a content of the first anchor point, the first anchor point is written to specified sectors on the optical disc, and if there is no change in the content of the first anchor point, the first anchor point is not written to the optical disc, wherein, if an error arises at the writing of the first anchor point, the UDF file system writing means performs a second error recovery operation for writing the second anchor point to specified sectors on the optical disc.

With the above configuration, each time information is recorded on the optical disc, the main volume descriptor sequence, the reserve volume descriptor sequence, and the logical volume integrity sequence, which have to be changed at each recording of information, are written (rewritten) to the sectors on the optical disc that are specified in the UDF standard. If an error arises at the writing, the three pieces of data are written to the reserved sectors on the optical disc. Accordingly, even when a writing error due to a defective sector arises at the writing of the main volume descriptor sequence, the reserve volume descriptor sequence, and the logical volume integrity sequence, the writing can be recovered. Further, when information is to be recorded on the optical disc, the first anchor point is written (rewritten) to the sectors on the optical disc that are specified in the UDF standard if there is a change in the content of the first anchor point. If a writing error arises at the writing of the first anchor point, the second anchor point is written (rewritten) to the sectors specified in the UDF standard. This can prevent an existing first anchor point on the specific sectors of the optical disc, which are defined in the UDF standard, from being unnecessarily overwritten with the first anchor point when there is no change in the content of the first anchor point. Accordingly, the specific sectors to which the first anchor point is written can be protected from damage or wear. Moreover, in the case where there is a change in the content of the first anchor point and a writing error due to a defective sector arises at the writing of the first anchor point, the writing can be recovered.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram schematically showing the configuration of an optical disc apparatus according to one embodiment of the present invention;

FIG. 2 shows the configuration of a UDF file system used for organizing information recorded on an optical disc by the optical disc apparatus;

FIGS. 3A to 3E show the configurations of a main volume descriptor sequence, a reserve volume descriptor sequence, a logical volume integrity sequence, a first anchor point, and a second anchor point, respectively, of the UDF file system; and

FIG. 4 is a flowchart showing a UDF file system writing process performed by the optical disc apparatus.

### DESCRIPTION OF THE PREFERRED EMBODIMENTS

Referring now to the accompanying drawings, an optical disc apparatus according to one embodiment of the present invention is described. It is to be noted that the following description of preferred embodiment of the present invention has been presented for purposes of illustration and description, and is not intended to be exhaustive or to limit the present invention to the precise form disclosed.

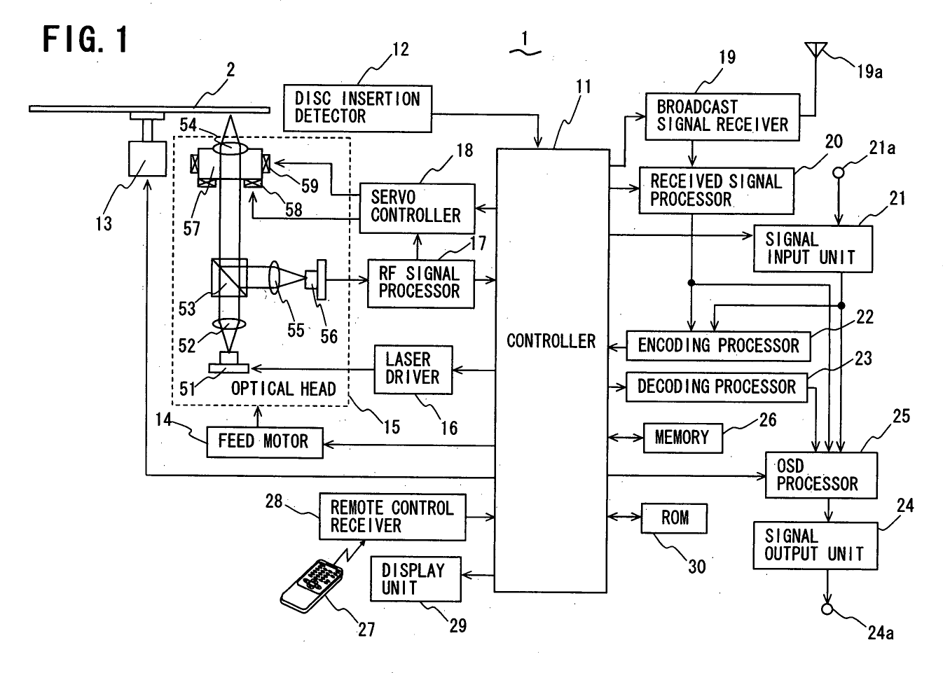

FIG. 1 shows the configuration of the optical disc apparatus 1 according to this embodiment. The optical disc apparatus 1 is an apparatus that records and/or reproduces information such as, for example, video, audio, and text on an optical disc 2 such as a DVD or the like. The optical disc apparatus 1 is adapted to record and/or reproduce information such as video, audio, and/or text on the optical disc 2 in accordance with the universal disk format (UDF) standard.

The optical disc apparatus 1 comprises a controller 11 (control means) including a central processing unit (CPU) for controlling each component in the optical disc apparatus 1, a disc insertion detector 12, a spindle motor 13, a feed motor 14, an optical head 15, a laser driver 16, an RF signal processor 17, and a servo controller 18. It is to be noted that recording and reading means comprises the spindle motor 13, the feed motor 14, the optical head 15, the laser driver 16, the RF signal processor 17, and the servo controller 18. The optical disc apparatus 1 further comprises a broadcast signal receiver 19, a received signal processor 20, a signal input unit 21, an encoding processor 22, a decoding processor 23, a signal output unit 24, an on-screen display (OSD) processor 25, a memory 26, a remote control 27, a remote control receiver 28, a display unit 29, and a read-only memory (ROM) 30.

The disc insertion detector 12 detects the optical disc 2 inserted into a disc insertion slot (not shown), and inputs the detection signal to the controller 11. The optical disc 2 inserted into the disc insertion slot is mounted on the spindle motor 13. The spindle motor 13 is rotated under the control of the controller 11 so as to rotate the mounted optical disc 2. The feed motor 14 comprises a linear motor, and moves the optical head 15 above the optical disc 2 in a radial direction of the optical disc 2.

The optical head 15 records information on the optical disc 2 by forming pits on the optical disc 2, and reads information recorded on the optical disc 2 by detecting pits formed on the optical disc 2. The optical head 15 comprises a semiconductor laser 51, a collimating lens 52, a beam splitter 53, an objective lens 54, a collecting lens 55 and a light receiving element 56.

The semiconductor laser 51 is driven by the laser driver 16 to emit light. The light emitted from the semiconductor laser 51 is collected and focused onto the optical disc 2 through the collimating lens 52, beam splitter 53, and objective lens 54. Light reflected from the optical disc 2 is collected onto the light receiving element 56 through the objective lens 54, beam splitter 53 and collecting lens 55. The objective lens 54 is held by a lens holder 57, and is moved in a direction perpendicular to the surface of the optical disc 2 and in a radial direction of the optical disc 2 by the magnetic force of a focusing coil 58 and a tracking coil 59 under the control of the servo controller 18. The movement of the objective lens 54 is used to adjust the position of the focused spot and the spot diameter of the light that is emitted from the semiconductor laser 51 and thereafter focused onto the optical disc 2. The light receiving surface of the light receiving element 56 is divided into multiple areas. The multiple areas of the light receiving element 56 respectively output electric signals according to the light intensities received thereby.

The optical head 15 irradiates the optical disc 2 with light emitted from the semiconductor laser 51, and thereby changes the properties of the recording layer of the optical disc 2, so as to form pits on the optical disc 2. Further, the optical head 15 irradiates the optical disc 2 with light emitted from the semiconductor laser 51 in order for the light receiving element 56 to receive light reflected from the optical disc 2, so as to detect the pits formed on the recording layer of the optical disc 2. For detecting the pits, the intensity of the light emitted from the semiconductor laser 51 is weakened so as to prevent the property change of the recording layer of the optical disc 2.

The laser driver 16 controls emission timing and emission intensity of the semiconductor laser 51 under the control of the controller 11. Based on output signals from the light receiving element 56, the RF signal processor 17 generates and outputs an RF signal (reflection intensity signal), a focusing error signal, and a tracking error signal. Based on the focusing error signal and the tracking error signal from the RF signal processor 17, the servo controller 18 drives the focusing coil 58 and the tracking coil 59, and thereby moves the objective lens 54 so as to control the position of the focused spot of the light that is emitted from the semiconductor laser 51 to be focused onto the optical disc 2.

Under the control of the controller 11, the receiving frequency of the broadcast signal receiver 19 is tuned to a frequency of a television broadcast signal transmitted from a broadcast station so as to receive the television broadcast signal via an antenna 19a. Under the control of the controller 11 the received signal processor 20 demodulates the television broadcast signal received by the broadcast signal receiver 19 so as to generate video and audio signals. Further, under the control of the controller 11, the signal input unit 21 receives various signals representing information such as video, audio, and text that are input via a signal input terminal 21a from external devices such as a video camera, a digital camera, and a personal computer.

The encoding processor 22 encodes video and audio signals generated by the received signal processor 20 and signals input through the signal input unit 21 into a given format for recording as encoded data on the optical disc 2, under the control of the controller 11. The decoding processor 23 decodes encoded data read from the optical disc 2 under the control of the controller 11.

Under the control of the controller 11, the signal output unit 24 outputs video and audio signals generated by the received signal processor 20, signals input through the signal input unit 21, and signals decoded by the decoding processor 23 to external devices such as a display, a speaker, and a personal computer via a signal output terminal 24a. Under the control of the controller 1, the OSD processor 25 superimposes on-screen image signals on the video signals generated by the received signal processor 20, the signals input through the signal input unit 21, and the signals decoded by the decoding processor 23 for display of an on-screen image on the display.

The memory 26 temporarily stores e.g. encoded data to be recorded on the optical disc 2 and encoded data read from the optical disc 2 under the control of the controller 11. Further, the memory 26 stores e.g. graphics data based on which the on-screen image is generated.

The remote control 27 is operated by a user to enter commands into the optical disc apparatus 1 for various operations including: selection of a channel on which television broadcast signals are to be received; recording of information such as video, audio, and/or text to the optical disc 2; and reproduction of information recorded on the optical disc 2. The remote control 27 has various operation keys (detailed description omitted) to be operated by the user for entering the various operation commands into the optical disc apparatus 1. When the user operates the various operation keys, the remote control 27 sends out coded infrared signals that correspond to the operations.

The remote control receiver 28 receives infrared signals sent out from the remote control 27, and converts the received infrared signals to electric signals, and further outputs, to the controller 11, the signals corresponding to the commands entered by the remote control 27. The display unit 29 is provided on a front panel of a main body of the optical disc apparatus 1 so as to display information indicating the operation requested by the remote control 27, operational states of the optical disc apparatus 1, and so on. The ROM 30 stores operation programs for the controller 11.

The controller 11 determines the contents of the operations by the remote control 27 based on the output signals from the remote control receiver 28, and controls various operations including an operation of receiving television broadcast signals, an operation of recording information such as video, audio, and/or text on the optical disc 2, and an operation of reproducing information recorded on the optical disc 2.

For recording information on the optical disc 2, the encoding processor 22 encodes video and audio signals generated by the received signal processor 20 or signals input through the signal input unit 21. Then, the optical head 15 forms on the optical disc 2 pits with lengths and arrangement corresponding to the encoded data.

For reproducing information recorded on the optical disc 2, the optical head 15 detects pits formed on the optical disc 2. Based on output signals of the optical head 15, the RF signal processor 17 generates and outputs RF signals. Based on the RF signals, the controller 11 determines the lengths and arrangement of the pits to read encoded data. Then, the decoding processor 23 decodes the encoded data so that the decoded signal is output through the signal output unit 24.

The optical disc 2 has recording tracks concentrically or spirally formed at a given pitch. Each of the recording tracks includes multiple sectors, in each of which an address value identifying the sector is prerecorded in the form of pits.

For recording/reading encoded data, the controller 11 causes the optical head 15 to irradiate the optical disc 2 with light and receive the reflected light while rotating the spindle motor 13 to cause the optical disc 2 to rotate. Based on pits detected by the optical head 15, i.e., on RF signals received from the RF signal processor 17, the controller 11 detects the address value of each sector for identification of the sector and records/reads encoded data sector by sector.

The controller 11 controls the above described operation of recording/reading encoded data (i.e., recording/reproducing information) on the optical disc 2 in accordance with the UDF standard. More particularly, when information is recorded on the optical disc 2, a UDF file system that is management information used for organizing the recorded information in accordance with the UDF standard is also written onto the optical disc 2. For reproducing information recorded on the optical disc 2, the information is read out based on a UDF file system written on the optical disc 2.

A UDF file system is written to the optical disc 2 in the following steps. First, a UDF file system previously recorded on the optical disc 2 is read (loaded). Subsequently, based on the read UDF file system and information to be recorded on the optical disc 2, a new UDF file system is created and written to the optical disc 2.

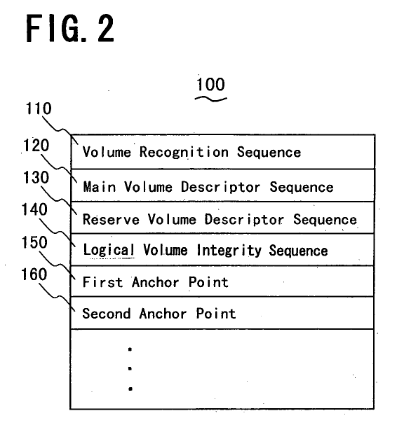

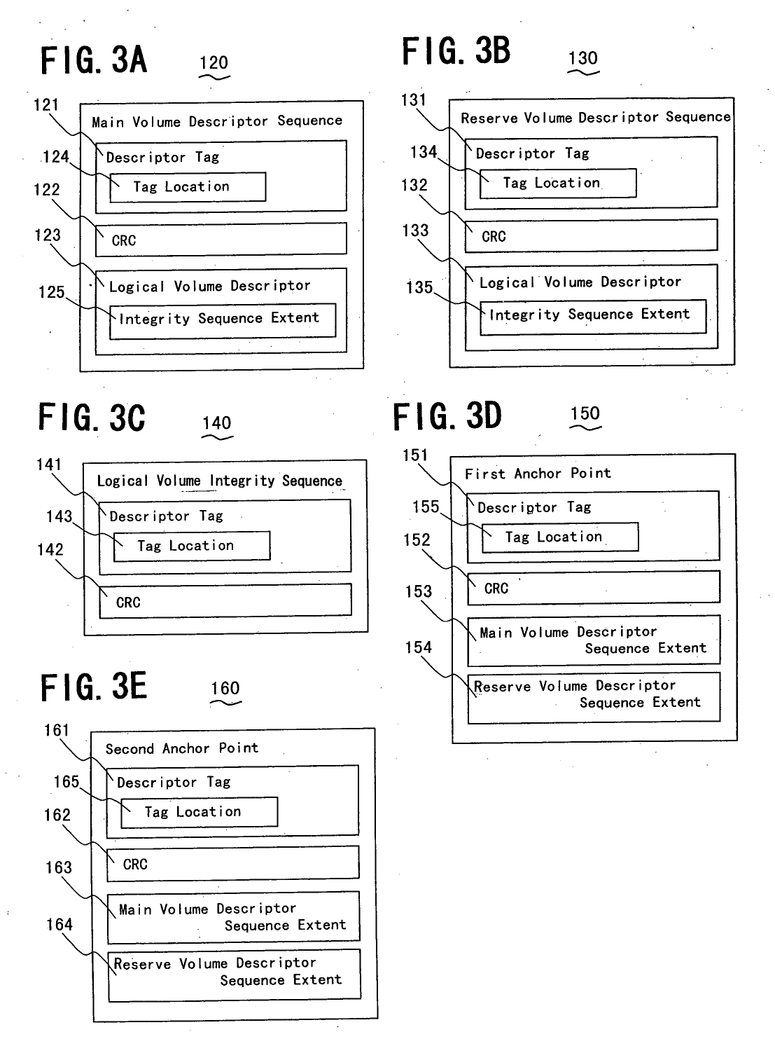

FIG. 2 and FIGS. 3A to 3E show the configuration of a UDF file system 100, which is information for organizing information recorded on the optical disc 2 in accordance with the UDF standard. As shown in FIG. 2, the UDF file system 100 includes a volume recognition sequence 110, a main volume descriptor sequence 120, a reserve volume descriptor sequence 130, a logical volume integrity sequence 140, a first anchor point 150, and a second anchor point 160.

The volume recognition sequence 110 is data indicating that the file system for organizing information recorded on the optical disc 2 is a UDF file system. Accordingly, the volume recognition sequence 110 has to be written to the optical disc 2 when information is recorded for the first time on the optical disc 2 in accordance with the UDF standard (when information is recorded on a blank disc). When information is recorded a second or subsequent time on the optical disc 2 in accordance with the UDF standard (when information is additionally recorded on the optical disc 2), there is no change in the content of the volume recognition sequence 110.

As shown in FIG. 3A, the main volume descriptor sequence 120 includes a descriptor tag 121, a cyclic redundancy check (CRC) 122, and a logical volume descriptor 123. The descriptor tag 121 includes a tag location 124, in which written is the address of the tag location 124 itself. Written in the CRC 122 is error detection data used for checking whether data in the main volume descriptor sequence 120 is properly written or not. The error detection data written in the CRC 122 is data corresponding to a remainder that, considering the bit sequence of the main volume descriptor sequence 120 as representing coefficients of a polynomial, is added to the polynomial so as to make the polynomial divisible by a predefined generator polynomial. The error detection data is calculated from the entire bit sequence of the main volume descriptor sequence 120. The logical volume descriptor 123 includes an integrity sequence extent 125, in which written is the start address of the logical volume integrity sequence 140.

As shown in FIG. 3B, the reserve volume descriptor sequence 130 includes a descriptor tag 131, a CRC 132, and a logical volume descriptor 133. The descriptor tag 131 includes a tag location 134, in which written is the address of the tag location 134 itself. Written in the CRC 132 is error detection data used for checking whether data in the reserve volume descriptor sequence 130 is properly written or not. The error detection data written in the CRC 132 is data corresponding to a remainder that, considering the bit sequence of the reserve volume descriptor sequence 130 as representing coefficients of a polynomial, is added to the polynomial so as to make the polynomial divisible by a predefined generator polynomial. The error detection data is calculated from the entire bit sequence of the reserve volume descriptor sequence 130. The logical volume descriptor 133 includes an integrity sequence extent 135, in which written is the start address of the logical volume integrity sequence 140.

As shown in FIG. 3C, the logical volume integrity sequence 140 includes a descriptor tag 141 and a CRC 142. The descriptor tag 141 includes a tag location 143, in which written is the address of the tag location 143 itself. Written in the CRC 142 is error detection data used for checking whether data in the logical volume integrity sequence 140 is properly written or not. The error detection data written in the CRC 142 is data corresponding to a remainder that, considering the bit sequence of the logical volume integrity sequence 140 as representing coefficients of a polynomial, is added to the polynomial so as to make the polynomial divisible by a predefined generator polynomial. The error detection data is calculated from the entire bit sequence of the logical volume integrity sequence 140.

The main volume descriptor sequence 120, the reserve volume descriptor sequence 130, and the logical volume integrity sequence 140 each have to be written to the optical disc 2 when information is recorded for the first time on the optical disc 2 in accordance with the UDF standard (when information is recorded on a blank disc). Further, when information is recorded a second or subsequent time on the optical disc 2 in accordance with the UDF standard (when information is additionally recorded on the optical disc 2), there are always changes in the contents of the main volume descriptor sequence 120, the reserve volume descriptor sequence 130, and the logical volume integrity sequence 140.

As shown in FIG. 3D, the first anchor point 150 includes a descriptor tag 151, a CRC 152, a main volume descriptor sequence extent 153, and a reserve volume descriptor sequence extent 154. The descriptor tag 151 includes a tag location 155, in which written is the address of the tag location 155 itself. Written in the CRC 152 is error detection data used for checking whether data in the first anchor point 150 is properly written or not. The error detection data written in the CRC 152 is data corresponding to a remainder that, considering the bit sequence of the first anchor point 150 as representing coefficients of a polynomial, is added to the polynomial so as to make the polynomial divisible by a predefined generator polynomial. The error detection data is calculated from the entire bit sequence of the first anchor point 150. Written in the main volume descriptor sequence extent 153 is the relative address of the main volume descriptor sequence 120 relative to the first anchor point 150. Written in the reserve volume descriptor sequence extent 154 is the relative address of the reserve volume descriptor sequence 130 relative to the first anchor point 150.

As shown in FIG. 3E, the second anchor point 160 includes a descriptor tag 161, a CRC 162, a main volume descriptor sequence extent 163, and a reserve volume descriptor sequence extent 164. The descriptor tag 161 includes a tag location 165, in which written is the address of the tag location 165 itself. Written in the CRC 162 is error detection data used for checking whether data in the second anchor point 160 is properly written or not. The error detection data written in the CRC 162 is data corresponding to a remainder that, considering the bit sequence of the second anchor point 160 as representing coefficients of a polynomial, is added to the polynomial so as to make the polynomial divisible by a predefined generator polynomial. The error detection data is calculated from the entire bit sequence of the second anchor point 160. Written in the main volume descriptor sequence extent 163 is the relative address of the main volume descriptor sequence 120 relative to the second anchor point 160. Written in the reserve volume descriptor sequence extent 164 is the relative address of the reserve volume descriptor sequence 130 relative to the second anchor point 160.

The first anchor point 150 or the second anchor point 160 has to be written to the optical disc 2 when information is recorded for the first time on the optical disc 2 in accordance with the UDF standard (when information is recorded on a blank disc). Further, when information is recorded a second or subsequent time on the optical disc 2 in accordance with the UDF standard (when information is additionally recorded on the optical disc 2), there may be changes in the content of the first or second anchor point 150 or 160.

According to the UDF standard, it is required that the above described pieces of information 110 to 164 of the UDF file system 100 are written to sectors specified in the UDF standard. Further, the UDF standard provides for sectors to be used as a user area for storing user data such as video, audio, and text and sectors to be used as a reserved area that can be used freely for various purposes by the optical disc apparatus 1.

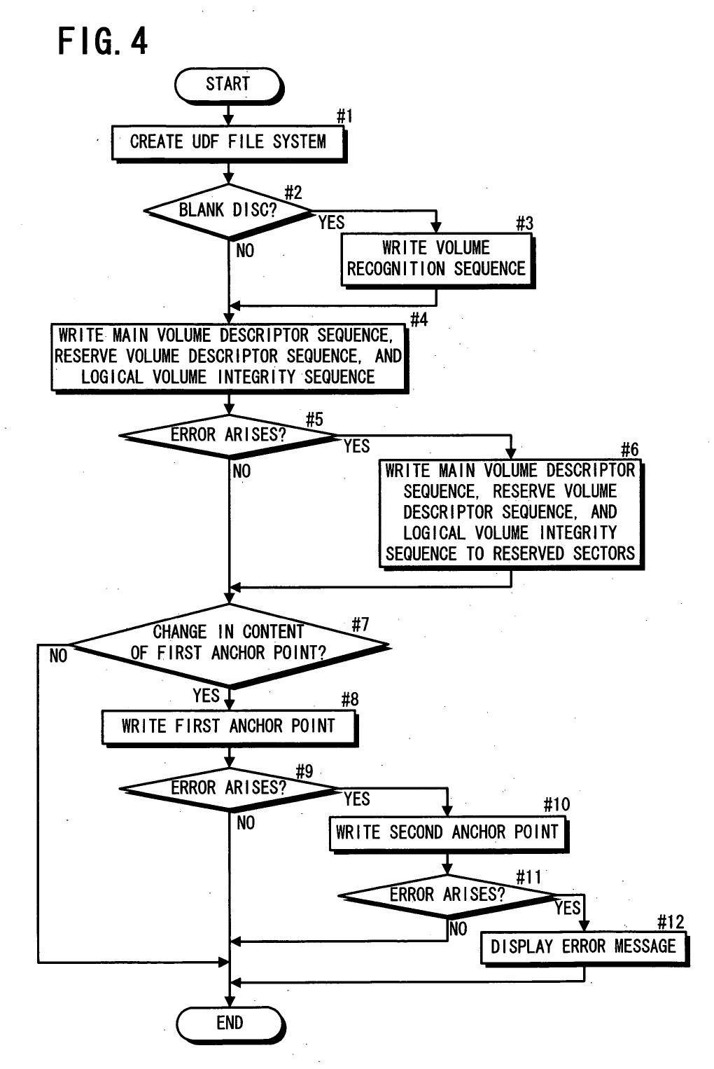

FIG. 4 is a flowchart showing a UDF file system 100 writing process performed by the optical disc apparatus 1. First in this process, the controller 11 creates a new UDF file system 100 to be written onto the optical disc 2 (#1). For creating the UDF file system 100, a previously recorded UDF file system is read (loaded) from the optical disc 2. Then, based on the read UDF file system and user data such as video, audio, and/or text to be recorded on the optical disc 2, the controller 11 performs operations of e.g. finding available space on the optical disc 2 and determining the sector addresses where the user data is to be recorded so as to create the new UDF file system 100.

After creating the UDF file system 100, the controller 11 determines whether or not the optical disc 2 is a blank disc (#2). If the optical disc 2 is blank, i.e., if it has no data recorded in accordance with the UDF standard, the optical disc 2 has no volume recognition sequence written thereon. On the other hand, if the optical disc 2 is not blank, i.e., if it contains data recorded in accordance with the UDF standard, the optical disc 2 has a volume recognition sequence previously written thereon. Accordingly, the controller 11 performs the determination as to whether or not the optical disc 2 is blank by determining the presence or absence of the volume recognition sequence on the optical disc 2. More particularly, if the optical disc 2 has no volume recognition sequence written thereon, the controller 11 determines that the optical disc 2 is blank. Otherwise if the optical disc 2 has a volume recognition sequence previously written thereon, the controller 11 determines that the optical disc 2 is not blank.

If the optical disc 2 is a blank disc (YES at #2), the controller 11 writes the volume recognition sequence 110 of the UDF file system 100 created at the step #1 to the specified sectors on the optical disc 2 (#3). On the other hand, if the optical disc 2 is not blank (No at #2), the controller 11 does not write the volume recognition sequence 110 of the new UDF file system 100 to the optical disc 2. In other words, the existing volume recognition sequence on the optical disc 2 is not overwritten.

Subsequently, the controller 11 writes the main volume descriptor sequence 120, reserve volume descriptor sequence 130, and logical volume integrity sequence 140 of the UDF file system 100 created at the step #1 to the specified sectors on the optical disc 2 (#4). In other words, the contents of the main volume descriptor sequence, reserve volume descriptor sequence, and logical volume integrity sequence previously written on the optical disc 2 are overwritten.

If a writing error arises at the step #4 (YES at #5), the controller 11 writes the main volume descriptor sequence 120, reserve volume descriptor sequence 130, and logical volume integrity sequence 140 of the UDF file system 100 created at the step #1 to sectors in the reserved area on the optical disc 2 (#6).

As described above, each of the main volume descriptor sequence 120, the reserve volume descriptor sequence 130, and the logical volume integrity sequence 140 contains data dependent on a sector address and data dependent on a bit sequence in a sector. Accordingly, at the step #6, it is necessary to change the contents of the data dependent on a sector address and the data dependent on a bit sequence in a sector that are contained in the UDF file system 100 created at the step #1. More particularly, the main volume descriptor sequence 120 is written to the reserved sectors after changing the tag location 124 in the descriptor tag 121, recalculating the CRC 122, and changing the integrity sequence extent 125 in the logical volume descriptor 123. Likewise, the reserve volume descriptor sequence 130 is written to the reserved sectors after changing the tag location 134 in the descriptor tag 131, recalculating the CRC 132, and changing the integrity sequence extent 135 in the logical volume descriptor 133. Further, the logical volume integrity sequence 140 is written to the reserved sectors after changing the tag location 143 in the descriptor tag 141 and recalculating the CRC 142.

Subsequently, if there is no change in the content of the first anchor point 150 (NO at #7), the controller 11 exits the UDF file system writing process without writing the first anchor point 150 of the UDF file system 100 created at the step #1, i.e., without overwriting the existing one on the optical disc 2. On the other hand, if there is a change in the content of the first anchor point 150 (YES at #7), the controller 11 writes the first anchor point 150 of the UDF file system 100 created at the step #1 to the specified sectors on the optical disc 2 (#8). In other words, the first anchor point previously written on the optical disc 2 is overwritten.

If no writing error arises at the writing step #8 (NO at #9), the controller 11 exits the UDF file system writing process. On the other hand, if a writing error arises at the step #8 (YES at #9), the controller 11 writes the second anchor point 160 of the UDF file system 100 created at the step #1 to the specified sectors on the optical disc 2 (#10). In other words, a second anchor point previously written on the optical disc 2 is overwritten.

As described above, the first and second anchor points 150 and 160 each have data dependent on a sector address and data dependent on a bit sequence in a sector. The data dependent on a sector address or on a bit sequence in a sector that is contained in the UDF file system 100 created at the step #1 is data for the first anchor point 150. Thus, at the step #10, it is necessary to change the data dependent on a sector address or on a bit sequence in a sector to data for the second anchor point 160. More particularly, the second anchor point 160 is written to the specified sectors on the optical disc 2 after determining the tag location 165 in the descriptor tag 161, calculating the CRC 162, and determining the main volume descriptor sequence extent 163 and the reserve volume descriptor sequence extent 164.

If no writing error arises at the step #10 (NO at #11), the controller 11 exits the UDF file system writing process. On the other hand, if a writing error arises at the step #10 (YES at #11), the controller 11 determines that the optical disc 2 is unusable. Thus, the controller 11 performs an error operation, e.g., displays an error message on the display unit 29 (#12) and exits the UDF file system writing process.

According to the optical disc apparatus 1 described above, the volume recognition sequence 110 is written to the specific sectors on the optical disc 2, which are defined in the UDF standard, only when the optical disc 2 on which information is to be recorded is a blank disc, i.e., has no volume recognition sequence written thereon. In other words, when the optical disc 2 is not blank, i.e., when it already has information recorded thereon and thus has a volume recognition sequence written thereon, the new volume recognition sequence 110 is not written to the optical disc 2, that is, the existing volume recognition sequence on the optical disc 2 is not overwritten. This can prevent the existing volume recognition sequence on the specific sectors of the optical disc 2, which are defined in the UDF standard, from being unnecessarily overwritten when additional information is to be recorded on the optical disc 2. Accordingly, the specific sectors used for storage of the volume recognition sequence can be protected from damage or wear.

The main volume descriptor sequence 120, reserve volume descriptor sequence 130, and logical volume integrity sequence 140 of the UDF file system 100 are written (rewritten) to the specific sectors on the optical disc 2, which are defined in the UDF standard, every time information is additionally recorded on the optical disc 2. If a writing error arises at the writing, the main volume descriptor sequence 120, the reserve volume descriptor sequence 130, and the logical volume integrity sequence 140 are written to the reserved sectors on the optical disc 2. Accordingly, even where a writing error due to a defective sector arises at the writing of the main volume descriptor sequence 120, the reserve volume descriptor sequence 130, and the logical volume integrity sequence 140, the writing can be recovered.

Further, at a recording of additional information on the optical disc 2, the first anchor point 150 of the UDF file system 100 is written (rewritten) to the specific sectors on the optical disc 2, which are defined in the UDF standard, only when there is a change in the content of the first anchor point 150. If a writing error arises at the writing of the first anchor point 150, the second anchor point 160 is written (rewritten) to the specific sectors on the optical disc 2 that are defined in the UDF standard. This can prevent an existing first anchor point on the specific sectors of the optical disc, which are defined in the UDF standard, from being unnecessarily overwritten with the first anchor point 150 when there is no change in the content of the first anchor point 150. Accordingly, the specific sectors to which the first anchor point 150 is written can be protected from damage or wear. Moreover, in the case where there is a change in the content of the first anchor point 150 and a writing error due to a defective sector arises at the writing of the first anchor point 150, the writing can be recovered.

The present invention has been described above using a presently preferred embodiment, but those skilled in the art will appreciate that various modifications are possible. Accordingly, all such modifications are intended to be included within the spirit and scope of the present invention. For example, the optical disc 2 is not limited to a DVD but can be any other recording medium to which the UDF is applicable. The UDF file system 100 can be written onto the optical disc 2 either before or after user data such as video, audio, and/or text is recorded on the optical disc 2.

This application is based on Japanese patent application 2004-362941 filed Dec. 15, 2004, the contents of which are hereby incorporated by reference.

What is claimed is:

1. An optical disc apparatus comprising:
recording and reading means for recording and reading information to and from an optical disc; and
control means for controlling the recording and reading of information to and from the optical disc in accordance with a universal disk format (UDF) standard,
wherein the control means includes UDF file system writing means for, when information is to be recorded on the optical disc, reading information previously written on the optical disc by the recording and reading means and writing, by the recording and reading means, at least a portion of a UDF file system onto the optical disc based on the information read from the optical disc and the information to be recorded on the optical disc, wherein the UDF file system is information used for organizing information recorded on the optical disc in accordance with the UDF standard and includes a volume recognition sequence, a main volume descriptor sequence, a reserve volume descriptor sequence, a logical volume integrity sequence, a first anchor point, and a second anchor point,
wherein the UDF file system writing means performs a recognition sequence writing operation in which, if it is determined that the optical disc is blank, the volume recognition sequence is written to specified sectors on the optical disc, and if it is determined that the optical disc is not blank, the volume recognition sequence is not written to the optical disc.

2. The optical disc apparatus according to claim 1,
wherein the optical disc is determined to be blank when the optical disc has no volume recognition sequence previously written thereon.

3. The optical disc apparatus according to claim 1,
wherein the UDF file system writing means performs a volume sequence writing operation for writing the main volume descriptor sequence, the reserve volume descriptor sequence, and the logical volume integrity sequence to specified sectors on the optical disc after it is determined that the optical disc is not blank or after it is determined that the optical disc is blank and thus the volume recognition sequence is written to the optical disc, and
wherein, if a writing error arises at the volume sequence writing operation, the UDF file system writing means performs an error recovery operation for writing the main volume descriptor sequence, the reserve volume descriptor sequence, and the logical volume integrity sequence to reserved sectors on the optical disc.

4. The optical disc apparatus according to claim 1,
wherein the UDF file system writing means performs a volume sequence writing operation for writing the main volume descriptor sequence, the reserve volume descriptor sequence, and the logical volume integrity sequence to specified sectors on the optical disc after it is determined that the optical disc is not blank or after it is determined that the optical disc is blank and thus the volume recognition sequence is written to the optical disc,
wherein, if a writing error arises at the volume sequence writing operation, the UDF file system writing means performs a first error recovery operation for writing the main volume descriptor sequence, the reserve volume descriptor sequence, and the logical volume integrity sequence to reserved sectors on the optical disc,
wherein, after the main volume descriptor sequence, the reserve volume descriptor sequence, and the logical volume integrity sequence are written to the optical disc by either the volume sequence writing operation or the first error recovery operation, the UDF file system writing means performs a first anchor point writing operation in which, if there is a change in a content of the first anchor point, the first anchor point is written to specified sectors on the optical disc, and if there is no change in the content of the first anchor point, the first anchor point is not written to the optical disc, and
wherein, if an error arises at the writing of the first anchor point, the UDF file system writing means performs a second error recovery operation for writing the second anchor point to specified sectors on the optical disc.
